(19) United States
(12) Patent Application Publication
(10) Pub. No.: US 2014/0020833 A1
(43) Pub. Date: Jan. 23, 2014

(54) SUBSTRATE PROCESSING APPARATUS

(71) Applicant: CANON ANELVA CORPORATION, Kawasaki-shi (JP)

(72) Inventors: Tatsuhiko Yoshida, Inagi-shi (JP); Masami Hasegawa, Kunitachi-shi (JP); Tomoaki Osada, Fuchu-shi (JP)

(73) Assignee: CANON ANELVA CORPORATION, Kawasaki-shi (JP)

(21) Appl. No.: 14/034,636

(22) Filed: Sep. 24, 2013

Related U.S. Application Data
(63) Continuation of application No. PCT/JP2012/001571, filed on Mar. 7, 2012.

(30) Foreign Application Priority Data
Mar. 31, 2011 (JP) 2011-079700

(51) Int. Cl. H05H 1/46

(52) U.S. Cl. CPC H05H 1/46
USPC 156/345.29

(57) ABSTRACT

A substrate processing apparatus for processing a substrate with plasma including: a container including a first container member that forms a processing space in which the substrate is processed, and a second container member that forms a plasma generation space in which plasma is generated a gas introduction unit for introducing gas into the container; a plasma generation unit including an antenna that is provided in an external space of the container and configured to excite the gas in the plasma generation space with an electric field that is generated by a high-frequency voltage fed from a power supply; and a substrate holding unit that is capable of holding the substrate. A coating film that contains a semiconductor material is formed on a surface of the second container member that is arranged close to the antenna.

### TECHNICAL FIELD

The present invention relates to a substrate processing apparatus for processing a substrate with plasma.

### BACKGROUND ART

As an example of a substrate processing apparatus for performing predetermined processing with plasma on a substrate, plasma CVD apparatuses and plasma dry etching apparatuses that use inductively coupled plasma are widely used. An inductively coupled dry etching apparatus is an apparatus that generates inductively coupled plasma (hereinafter referred to as plasma) by applying a high voltage to gas introduced into a reaction chamber, in which gas is reacted, and exciting the gas, and performs dry etching on a surface of a substrate disposed in a substrate processing chamber. As the inductively coupled dry etching apparatus, Patent Reference 1, for example, discloses a configuration in which an antenna 41 winds around a bell jar 42 as illustrated in FIG. 4. A high-frequency voltage is applied from a high-frequency power supply 43, and plasma is generated in a plasma generation space within the bell jar 42.

In the inductively coupled dry etching apparatus, ultraviolet light is emitted from the plasma that was generated in the reaction chamber by gas for use in generating plasma, and if this ultraviolet light leaks from the bell jar 42 to the outside, the ultraviolet light can react with oxygen in air so as to generate ozone. In Patent Reference 1, the bell jar 42 is made from a material having an insulating property such as quartz glass, and the external surface of the bell jar 42 is coated with an insulating film for blocking ultraviolet light, thereby blocking the ultraviolet light emitted from the plasma.

### PRIOR ART DOCUMENT(S)

### Patent Reference

Patent reference 1: Japanese Patent Laid-Open No. 2009-26885

### SUMMARY OF INVENTION

### Problems that the Invention is to Solve

However, in the configuration as disclosed in Patent Reference 1, the vicinity of a power receiving point to which a high-frequency voltage is applied from the high-frequency power supply 43 exhibits a state in which an electric field intensity is locally high (a state in which an electric field is concentrated). If the state in which an electric field is concentrated continues, (1) local erosion (LE) of the bell jar may occur in the vicinity of the power receiving point, resulting in a short replacement cycle of the bell jar 42, (2) particles, if generated due to the local erosion (LE) of the bell jar 42, may adhere to a surface of the substrate disposed in the substrate processing chamber, and (3) further, the local erosion (LE) of the bell jar 42 may cause a high impedance region and a low impedance region thereof, resulting in uneven distribution of plasma that is generated in the bell jar 42.

In the configuration of Patent Reference 1, since the bell jar 42 is made from a material having an insulating property such as quartz glass, electric characteristics of the bell jar 42 is not changed even if the bell jar 42 having an insulating property is coated with the insulating film. Therefore, the state in which an electric field intensity is locally high in the vicinity of the power receiving point is not eliminated even by coating the bell jar 42 with the insulating film, and thus the problems of the above-described items (1) to (3) are still not solved.

### Means of Solving the Problems

The present invention was made in view of the above-described problems, and it is an object of the present invention to provide a technology that is excellent in productivity, prevents particles from being generated within a space in which a substrate is processed, or is capable of improving uniformity in plasma generation.

A substrate processing apparatus according to one aspect of the present invention is a substrate processing apparatus for processing a substrate with plasma, including:

a container including a first container member that forms a processing space in which the substrate is processed, and a second container member that forms a plasma generation space in which plasma is generated and that is in communication with the processing space in a state in which the second container member is mounted on the first container member;

a gas introduction unit for introducing gas into the container;

a plasma generation unit including an antenna that is provided in an external space of the container and configured to excite the gas in the plasma generation space with an electric field that is generated by a high-frequency voltage fed from a power supply; and

a substrate holding unit that is capable of holding the substrate in the processing space;

wherein a coating film that contains a semiconductor material is formed on a surface of the second container member that is arranged close to the antenna.

### Effects of the Invention

According to the present invention, there is provided a technology that is excellent in productivity, prevents particles from being generated within a space in which a substrate is processed, and is capable of improving uniformity in plasma generation.

Other features and advantages of the present invention will become apparent from the following description with reference to the attached drawings. Note that the same reference numerals are given to the same or similar components in the attached drawings.

### BRIEF DESCRIPTION OF DRAWINGS

The attached drawings are included in the specification, constitute a part thereof, illustrate embodiments of the present invention, and are used to describe the principle of the present invention together with the description of the embodiments.

FIG. 1 is a diagram illustrating a configuration of a substrate processing apparatus according to an embodiment;

FIG. 2 is a diagram illustrating coating of a second container member (bell jar);

FIG. 3 is a diagram illustrating coating of the second container member (bell jar);

FIG. 4 is a diagram illustrating a conventional technology; and

FIG. 5 is a diagram illustrating experiment results.

### MODE FOR CARRYING OUT THE INVENTION

Hereinafter, a preferred embodiment of the present invention will be described in detail as an example with reference to the drawings. However, constituent components described in this embodiment are merely examples, and the technical scope of the present invention is defined by Claims and is not limited by the individual embodiment to be described later.

A configuration of the substrate processing apparatus

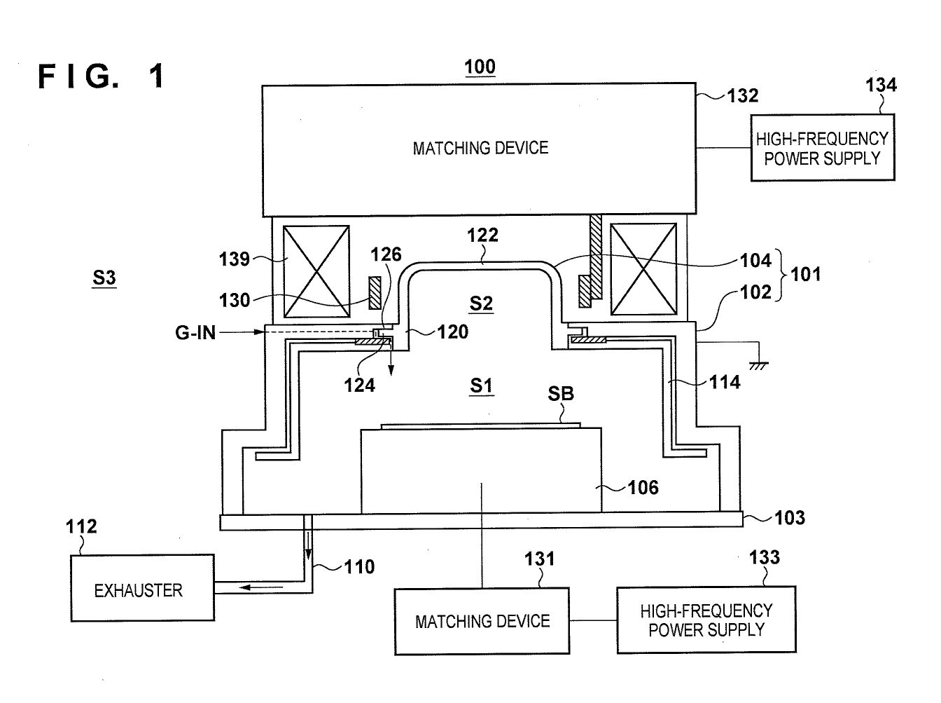

A schematic configuration of a substrate processing apparatus 100 according to an embodiment of the present invention will be described with reference to FIG. 1. The substrate processing apparatus 100 includes a container 101 as a structure for separating a space in which a substrate SB is processed from an external space S3 having an atmospheric pressure. The container 101 includes a diffusion chamber (hereinafter, referred to as a first container member) 102 and a bell jar (hereinafter, referred to as a second container member) 104. The first container member (diffusion chamber) 102 forms a processing space S1 in which the substrate SB is processed. The second container member (bell jar) 104 forms a plasma generation space S2 in which plasma is generated and that is in communication with the processing space S1 in a state in which the second container member is mounted on the first container member. The first container member (diffusion chamber) 102 is supported by a base member 103.

A shielding member 114 for preventing a reaction product generated by plasma from adhering to an internal wall of the first container member (diffusion chamber) 102 is provided on the internal wall of the first container member (diffusion chamber) 102. The shielding member 114 is detachable in order to make an efficient maintenance operation possible.

A substrate holding unit 106 that is capable of holding the substrate SB is provided in the processing space S1 of the first container member (diffusion chamber) 102. The substrate holding unit 106 includes electrodes for electrostatically adsorbing the substrate SB or biasing the substrate SB, and the electrodes are connected to a high-frequency power supply 133 via a matching device 131.

The first container member (diffusion chamber) 102 and the shielding member 114 are provided with gates (not shown) through which the substrate SB to be processed is carried into the processing space S1 or the substrate SB that was processed is carried out of the processing space S1. The base member 103 is provided with an exhaust pipe 110 that is connected to an exhauster 112 that includes a vacuum pump capable of reducing the pressure in the processing space S1 and the plasma generation space S2 to a predetermined vacuum degree.

The second container member (bell jar) 104 has a side wall portion 120, and a ceiling portion 122 that is formed at the upper end of the side wall portion 120. The side wall portion 120 and the ceiling portion 122 are formed as a single unit. The side wall portion 120 is open at the lower end thereof, and the plasma generation space S2 and the processing space S1 can be in communication with each other via this opening.

A flange 124 is formed on the outer periphery of the side wall portion 120 near the opening thereof and, for example, a sealing member such as an 0-ring is arranged on a sealing surface 126 of the flange 124. When the second container member (bell jar) 104 is mounted on the first container member (diffusion chamber) 102, the sealing member arranged on the sealing surface 126 maintains air tightness at a position in which the first container member 102 and the second container member 104 are coupled to each other. In other wards, the processing space S1 and the plasma generation space S2 constitute a closed space against the external space S3 having an atmospheric pressure, and are separated from the external space S3, thereby the vacuum degree in the processing space S1 and the plasma generation space S2 being maintained.

A gas introduction unit G-IN introduces gas into the container 101. For example, as the gas that is introduced by the gas introduction unit G-IN, alcohol-containing gas may be used alone or mixed gas in which inert gas such as argon gas is added may be used.

An antenna 130 is arranged in the external space S3 so as to be close to the second container member (bell jar) 104 that constitutes the container 101. A high-frequency voltage is fed to the antenna 130 from a high-frequency power supply 134 via a matching device 132. The matching device 132 performs impedance matching in order to efficiently supply high-frequency power to the plasma generation space S2 via the antenna, irrespective of a variation in the configuration of the second container member 104 or a change in plasma or the like of the plasma generation space S2.

By a predetermined high-frequency voltage being fed to the antenna 130 from the high-frequency power supply 134, an induction field (hereinafter, referred to as an electric field) occurs in the plasma generation space S2 within the second container member (bell jar) 104. This induction field causes gas introduced by the gas introduction unit G-IN to be excited in the plasma generation space, and inductively coupled plasma (hereinafter, referred to as “plasma”) is generated. An electromagnet 139 is arranged on the outer periphery portion of the antenna 130, and is configured to diffuse the plasma in the plasma generation space S2 toward the substrate SB in the processing space S1. Here, the antenna 130, the matching device 132, the high-frequency power supply 134, and the electromagnet 139 serve as a plasma generation unit for generating plasma in the plasma generation space S2.

When plasma is generated in the plasma generation space S2 within the second container member (bell jar) 104, ultraviolet light is emitted from this plasma. The second container member (bell jar) 104 is made from, for example, an insulating material such as quartz glass, and if the ultraviolet light passes through the second container member (bell jar) 104, the ultraviolet light may react with oxygen in the external space S3 and generate ozone.

Coating of the second container member

The second container member (bell jar) 104 is arranged at a position that is close to the antenna 130 arranged in the external space S3 having an atmospheric pressure, and a coating film containing a semiconductor material is formed on a surface of the second container member. The coating film containing a semiconductor material realizes advantageous effects particularly in (i) blocking ultraviolet light that has leaked from the second container member (bell jar) 104 toward the external space S3, and (ii) easing the concentration of an electric field that is generated at the power receiving point of the high-frequency voltage.

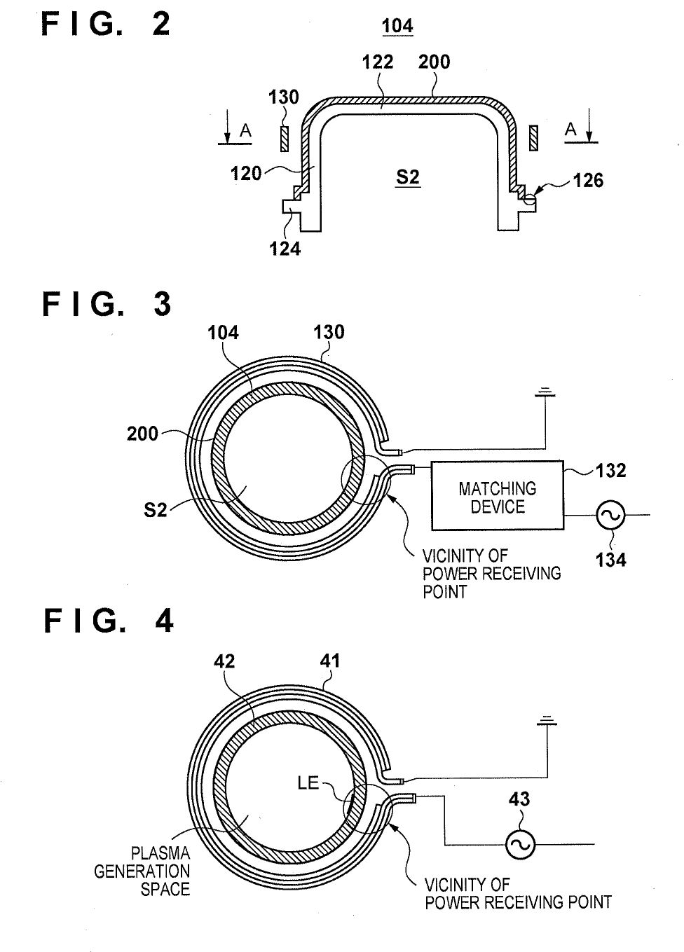

FIG. 2 illustrates an example in which a coating film 200 made from a semiconductor material is formed on the external surface of the second container member (bell jar) 104. In order to form a more robust and stable coating film on the external surface of the second container member (bell jar) 104 while preventing the coating film from being detached, the external surface of the second container member (bell jar) 104 is subjected to blast processing as a pretreatment so as to become a rough surface.

The coating film 200 is formed on the second container member (bell jar) 104 by thermal spraying. In the thermal spraying, a semiconductor material (thermal spray material) is first fluidified and sprayed by a high-speed gas stream onto the surface of the second container member (bell jar) 104 that is a target to be coated. The semiconductor material (thermal spray material) solidifies on and adheres to the surface of the second container member (bell jar) 104, and thereby the coating film made from the semiconductor material (thermal spray material) can be formed. Thermal spraying is advantageous processing in view of reducing thermal influence to be exerted on the second container member (bell jar) 104 since less heat is input to the second container member (bell jar) 104 than in processing such as welding. Also, similar to painting processing and the like, thermal spraying is advantageous processing in view of being performable only on a specific portion of the second container member (bell jar) 104 using masking. A semiconductor material (thermal spray material) is sprayed by thermal spraying onto the external surface of the second container member (bell jar) 104 that was made rough by blast processing, and solidified thereon. With such processing, sufficient engagement of particles of the semiconductor material (thermal spray material) with recesses and projections of the rough surface is ensured, and an improvement in adhesion strength between the second container member (bell jar) 104 and the semiconductor material (thermal spray material) is achieved.

In FIG. 2, a coated area where the coating film 200 is formed is located on the external surface of the second container member (bell jar) 104 that excludes the sealing surface 126. Using masking, the sealing surface 126 is excluded from the coated area. The reason why the sealing surface 126 is excluded from the coated area is to take the following two points into consideration: (i) the sealing performance may be deteriorated due to the formation of the coating film 200; and (ii) since the second container member (bell jar) 104 is mounted on the first container member(diffusion chamber) 102 (FIG. 1) via a sealing member (e.g., an O-ring) that is an elastic member, an effect to block ultraviolet light may be lower in the sealing surface 126, even if coated with the coating film 200, than in other portion of the external surface.

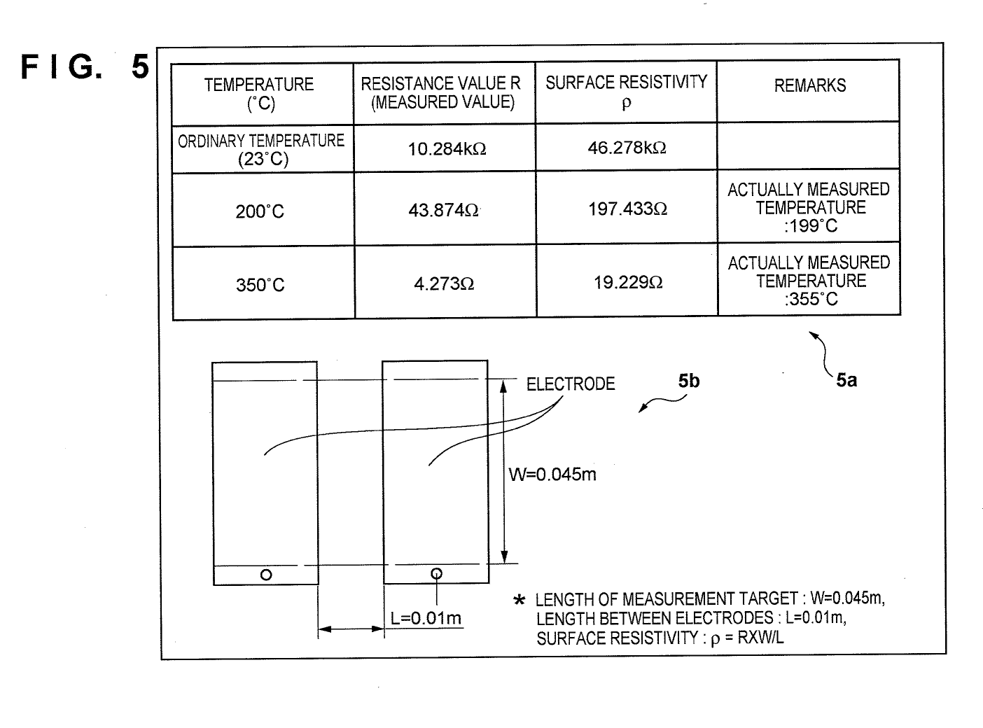

As a semiconductor material, silicon (Si), which is excellent in affinity with a material (such as quartz) that configures the second container member (bell jar) 104, is preferably used. FIG. 5 is a diagram illustrating results of measurement of surface resistances in the case where silicon (Si) as the semiconductor material is used for thermal spraying.

(1) Measurement target: a sample (50 mm×50 mm) that was thermally sprayed with silicon (Si)

(2) Measurement device:

HIOKI 3522-50 LCR HiTESTER

Shimadzu GAS CHROMATOGRAPH GC-12A (a constant temperature reservoir)

METEX M-3850D (a thermocouple instrument)

(3) Measurement conditions

Measurement temperature: 23° C. (ambient temperature), 200° C., and 350° C.

Measurement voltage: 1 V

Except for the measurement at the ordinary temperature (23° C. (ambient temperature)), the sample placed on a measurement fixture (not shown) was put into the constant temperature reservoir, the temperature was increased stepwise to the above-described measurement temperatures, and the resistance values R of the sample at those points in time were measured.

As illustrated by 5b of FIG. 5, the length W of the measurement target is set at 0.045 m (45 mm), and the length L between the electrodes is set at 0.01 m (10 mm).

The surface resistivity ρ can be obtained by ρ=R×W/L, where R is a resistance value (measurement value), W is the length of the measurement target, and L is the length between the electrodes.

The bell jar that was thermally sprayed with Si is heated rapidly during the process. The temperature may exceed 300° C. during use depending on the process, but it is affirmed that plasma is maintained, instead of diminishing, even in that case. Stable plasma is difficult to be maintained if the resistance value decreases too much, but plasma can be stably maintained as long as the temperature of the bell jar is approximately 350° C. despite Si being heated and the resistance value decreasing.

It is clear from the experiment results illustrated by 5a of FIG. 5 that plasma can be generated and maintained while plasma density distribution is made uniform if the resistance value (measurement value R) is in a range of 4.273 Ω to 10.284 kΩ (the surface resistivity is in a range of 19.229 Ω to 46.278 kΩ), which is the range of the resistance value (the surface resistivity) when Si is being heated from the ordinary temperature (23° C. (ambient temperature)) to approximately 350° C. That is, a semiconductor material whose resistance value (surface resistivity) is in the range illustrated in 5a can be used as the thermal spray material. Note that if a semiconductor material having a low resistance value is used as the thermal spray material, a reduction in the resistance value (surface resistivity) is suppressed by cooling the bell jar with the use of cooling means during the process, in order to enable plasma to be generated and maintained. As a cooling method, a method for cooling the bell jar with wind using a fan or a method for cooling the bell jar with water is applicable.

By forming the coating film 200 containing a semiconductor material on the external surface of the second container member (bell jar) 104, it is possible to block ultraviolet light emitted from plasma. Accordingly, it is possible to prevent the ultraviolet light from reacting with oxygen in air outside the substrate processing apparatus 100, and prevent ozone from being generated.

Note that although FIG. 2 has taken the example in which the coating film 200 containing a semiconductor material is directly formed on the second container member (bell jar) 104, the concept of the present invention is not limited to this example. For example, a film having an insulating property may be formed as an intermediate layer on the second container member (bell jar) 104, and then the coating film 200 containing a semiconductor material may be formed on the intermediate layer.

FIG. 3 is a diagram illustrating the second container member (bell jar) 104 in cross-section taken along the line A-A in FIG. 2, the matching device 132, and the high-frequency power supply 134. For the sake of ease, FIG. 3 illustrates a case of a one-turn antenna 130. The antenna 130, which includes two terminals, that is, a power receiving terminal that receives the supply of a high-frequency voltage and a ground terminal that is grounded, is arranged close to the outer periphery of the second container member (bell jar) 104. By forming the coating film 200 containing a semiconductor material on the external surface of the second container member (bell jar) 104, it is possible to ease the concentration of an electric field that is generated in the vicinity of the power receiving terminal (in the vicinity of the power receiving point) to which a high-frequency voltage is fed, and to distribute the electric field over the surface of the second container member (bell jar) 104.

If a conductive metallic film is formed on the external surface of the second container member (bell jar) 104, there is a problem that electricity is fed through the metallic film and, due to electromagnetic induction, electric power is not supplied into the second container member (bell jar) 104. Also, if a film made from a material having an insulating property is formed on the second container member 104, coating of the second container member (bell jar) 104, which itself is made from a material having an insulating property such as quartz, with the material having an insulating property causes no change in the electric characteristics. Therefore, the conductive metallic film and the film made from a material having an insulating property cannot ease the concentration of an electric field that is generated in the vicinity of the power receiving point of the second container member (bell jar) 104.

The semiconductor material for use as the coating film 200 has electric characteristics such that the volume resistivity R thereof is in a range of, for example, 1.5×10⁻⁵ Ωm (1.5×10 E-5 Ωm)≦R≦4000 Ωm. As the semiconductor material, a semiconductor material (such as silicon) that has the above-described electric characteristics and is excellent in affinity with a material (such as quartz) configuring the second container member (bell jar) 104 is preferably used. Note that although FIG. 2 has described the example in which the coating film 200 is formed on the external surface of the second container member (bell jar) 104, the concept of the present invention is not limited to this example, and a similar effect can be obtained even by forming the coating film 200 on the internal surface of the second container member (bell jar) 104.

The substrate processing apparatus 100 of the present embodiment realizes advantageous effects to block ultraviolet light emitted from plasma, and to enable the concentration of an electric field that is generated in the vicinity of the power receiving point to be eased and the electric field to be distributed over the surface of the second container member (bell jar) 104. Distributing the electric field over the surface of the second container member 104 can suppress the occurrence of local erosion within the second container member (bell jar) 104, and make the replacement cycle of the second container member 104 longer. Alternatively, by the occurrence of local erosion within the second container member (bell jar) 104 being suppressed, particles to be generated in the plasma generation space S2 can be reduced. Alternatively, it is possible to generate plasma in the second container member (bell jar) 104 in uniform distribution. According to the substrate processing apparatus 100 of the present embodiment, it is possible to realize a substrate processing technology that ensures high quality and is excellent in productivity.

A Device Manufacturing Method

The above-described substrate processing apparatus 100 is advantageous to substrate processing for manufacturing a device such as a semiconductor or a liquid crystal. The method for manufacturing a device includes a holding step of holding a substrate by the substrate holding unit 106 of the substrate processing apparatus 100, and an introduction step of introducing gas into the container 101 by the gas introduction unit G-IN of the substrate processing apparatus 100. The method for manufacturing a device also includes a generation step of exciting the gas and generating plasma by the plasma generation unit of the substrate processing apparatus 100, and a processing step of processing the substrate with the plasma.

The present invention is not limited to the above-described embodiment, and various changes and modifications are possible without departing from the spirit and scope of the present invention. Therefore, in order to make the scope of the present invention public, the following claims are attached.

This application claims the benefit of Japanese Patent Application No. 2011-79700, filed Mar. 31, 2011, which is hereby incorporated by reference herein in its entirety.

1. A substrate processing apparatus for processing a substrate with plasma, comprising:
a container including a first container member that forms a processing space in which the substrate is processed, and a second container member that forms a plasma generation space in which plasma is generated and that is in communication with the processing space in a state in which the second container member is mounted on the first container member;
a gas introduction unit for introducing gas into the container;
a plasma generation unit including an antenna that is configured to excite the gas in the plasma generation space with an electric field that is generated by a high-frequency voltage fed from a power supply; and
a substrate holding unit that is capable of holding the substrate in the processing space;
wherein the container separates the processing space and the plasma generation space from an external space having an atmospheric pressure,
the antenna is arranged in the external space so as to be close to the second container member, and
a coating film that contains a semiconductor material and is exposed to the external space is formed on a surface of the second container member that is on the external space.

2. The substrate processing apparatus according to claim 1,
wherein the coating film has a volume resistivity R in a range of 1.5×10⁻⁵ Ωm≦R≦4000 Ωm.

3. The substrate processing apparatus according to claim 1,
wherein the second container member is made from an insulating material, and an external surface thereof is subjected to blast processing, and
the coating film is formed on the external surface of the second container member that was subjected to the blast processing.

4. The substrate processing apparatus according to claim 1,
wherein the coating film contains silicon.

5. The substrate processing apparatus according to claim 1, further comprising;
a cooling unit configured to cool the coating film.
